(19) United States
(12) Patent Application Publication
(10) Pub. No.: US 2026/0246208 A1
(43) Pub. Date: Aug. 20, 2026

(54) BOARD CONNECTOR

(71) Applicant: Yazaki Corporation, Tokyo (JP)

(72) Inventors: Kazuki HATTORI, Shizuoka (JP); Daisuke Sakurai, Shizuoka (JP)

(73) Assignee: Yazaki Corporation, Tokyo (JP)

(21) Appl. No.: 19/533,494

(22) Filed: Feb. 9, 2026

(30) Foreign Application Priority Data
Feb. 19, 2025 (JP) 2025-025117

(51) Int. Cl. H01R 13/659; H01R 12/70; H01R 12/71; H01R 13/428

(52) U.S. Cl. CPC H01R 13/659; H01R 12/7064; H01R 12/7082; H01R 12/714; H01R 13/428

(57) ABSTRACT

A board connector includes an inner terminal, an inner housing, an outer terminal, a shield shell, an outer housing, and a lid member. The outer terminal includes a large diameter portion that contacts with a mating outer terminal, and is conducted therewith, a joining portion that is positioned by abutting against the outer housing, and a small diameter portion in which the inner housing is accommodated. A spring locking piece portion that is bent into a folded shape is formed at a terminal end portion of the small diameter portion, and the spring locking piece portion is sandwiched between the shield shell and the lid member.

### CROSS-REFERENCE TO RELATED APPLICATIONS

The present application is based on, and claims priority from the prior Japanese Patent Application No. 2025-025117, filed on February 19, 2025, the entire contents of which are incorporated herein by reference.

### TECHNICAL FIELD

The present disclosure relates to a board connector.

### BACKGROUND

In the related art, for example, there has been known a board connector that is installed on a circuit board. JP 2023-8309 A discloses a technique relating to a board connector that is also referred to as a PCB connector and is configured to be fitted into a mating connector. The mating connector is connected to a coaxial line that transmits a high-frequency signal or the like. Each of the connector and the mating connector includes a shielding function of suppressing leakage of electromagnetic waves caused by a signal transmitted through the coaxial line and entry of electromagnetic waves from outside. From this point of view, the above-mentioned connector is also referred to as a shield connector. Further, the above-mentioned connector includes a housing, a shield shell, a front-and-rear partition plate, an outer terminal, a guide sleeve, and an inner terminal.

### SUMMARY OF THE INVENTION

The outer terminal is inserted from a front side of the housing, passes through an accommodation hole of the shield shell, and then is fixed by bending a locking piece. However, when an external force is applied to the mating connector in a state in which the mating connector is fitted into the connector, a load is transmitted to the outer terminal of the connector, and the locking piece of the outer terminal may be deformed, which may reduce a holding force.

An object of the present disclosure is to provide a board connector capable of improving a holding force of an outer terminal with respect to a shield shell.

A board connector according to an embodiment includes an inner terminal that is electrically connected to a circuit board, and contacts with a mating inner terminal of a mating connector, an inner housing that includes an accommodation portion accommodating the inner terminal, an outer terminal that covers a part of the inner terminal, is electrically connected to the circuit board, and contacts with a mating outer terminal of the mating connector, a shield shell that includes a holding hole portion through which the outer terminal passes for holding the outer terminal, an outer housing that accommodates and holds the outer terminal and the shield shell, and a lid member that is assembled to the shield shell. The outer terminal includes a large diameter portion that contacts with the mating outer terminal, and is conducted therewith, a joining portion that is positioned by abutting against the outer housing, and a small diameter portion in which the inner housing is accommodated. A spring locking piece portion that is bent into a folded shape is formed at a terminal end portion of the small diameter portion, the spring locking piece portion being sandwiched between the shield shell and the lid member.

According to the above-mentioned configuration, it is possible to provide a board connector capable of improving a holding force of an outer terminal with respect to a shield shell.

### BRIEF DESCRIPTION OF DRAWINGS

FIG. 1 is a perspective view illustrating a state in which a board connector according to the present embodiment is mounted on a circuit board.

FIG. 2 is a perspective view of the board connector.

FIG. 3 is an exploded perspective view of the board connector.

FIG. 4 is a side cross-sectional view of the board connector.

FIG. 5 is a cross-sectional view taken along the line A-A of FIG. 4.

FIG. 6 is a cross-sectional view taken along the line B-B of FIG. 4.

FIG. 7 is an enlarged view of the part C of FIG. 6.

FIG. 8 is a side view of an inner terminal at a lower step.

FIG. 9 is a plan view of an inner housing at an upper step as viewed from above.

FIG. 10 is a front view of the inner housing at the upper step as viewed from a front side.

FIG. 11 is a cross-sectional view taken along the line D-D of FIG. 10.

FIG. 12 is a front view of an inner housing at a lower step as viewed from a front side.

FIG. 13 is a cross-sectional view taken along the line E-E of FIG. 12.

FIG. 14 is a front view of an outer housing as viewed from a front side.

FIG. 15 is a plan view of the outer housing as viewed from above.

FIG. 16 is a side view of the outer housing.

FIG. 17 is a cross-sectional view taken along the line F-F of FIG. 14.

FIG. 18 is a front view of a shield shell as viewed from a front side.

FIG. 19 is a cross-sectional view taken along the line G-G of FIG. 18.

FIG. 20 is a back view of the shield shell as viewed from a rear side.

FIG. 21 is a plan view of the shield shell as viewed from below.

FIG. 22 is a front view of the outer housing as viewed from a front side.

FIG. 23 is a cross-sectional view taken along the line H-H of FIG. 22.

FIG. 24 is a back view of the outer housing as viewed from a rear side.

FIG. 25 is a front view of a lid as viewed from a front side.

FIG. 26 is a plan view of the lid as viewed from above.

FIG. 27 is an explanatory diagram of an assembly procedure of the board connector.

FIG. 28 is an explanatory diagram of the assembly procedure of the board connector.

FIG. 29 is an explanatory diagram of the assembly procedure of the board connector.

FIG. 30 is an explanatory diagram of the assembly procedure of the board connector.

### DETAILED DESCRIPTION OF THE INVENTION

With reference to the drawings, a board connector according to the present embodiment is described below in detail. Note that the dimensional ratios in the drawings are exaggerated for explanatory purposes, and may differ from the actual ratios.

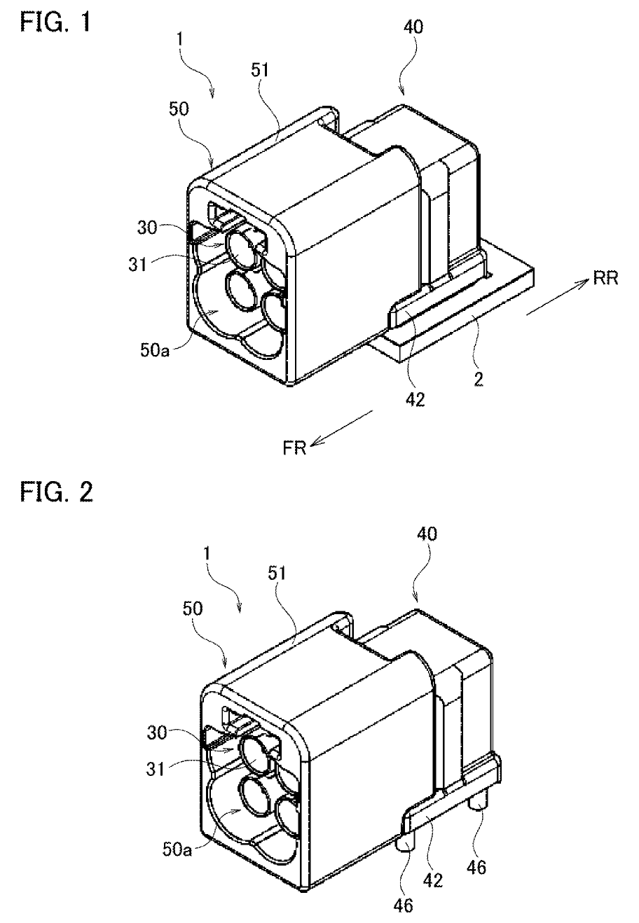

As illustrated in FIG. 1, a board connector 1 according to the present embodiment is a male connector for high frequency use, which is also referred to as a printed circuit board (PCB) connector, and can be fitted into a mating connector (female connector) omitted in illustration.

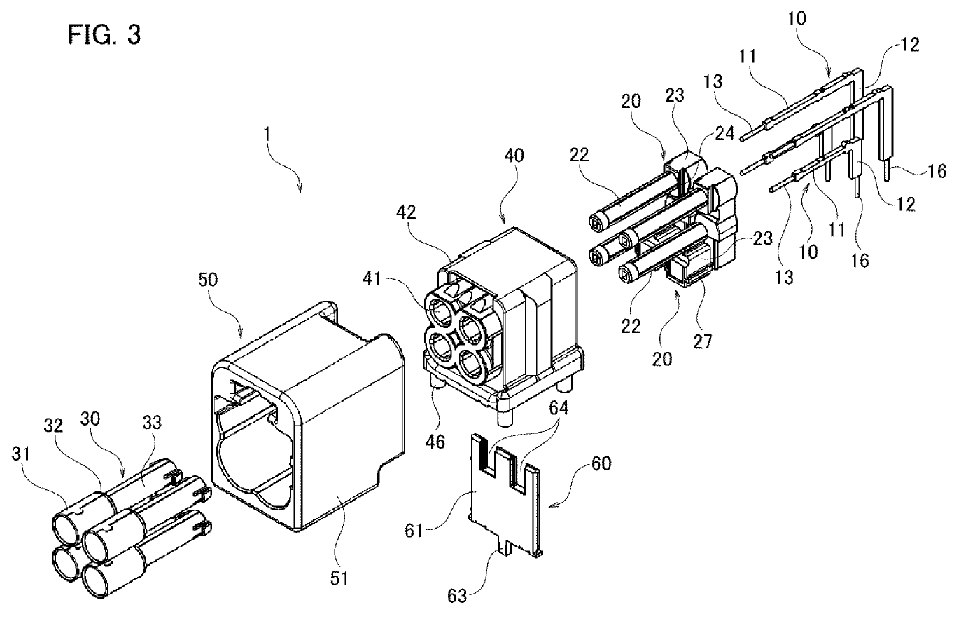

As illustrated in FIG. 1 to FIG. 7, the board connector 1 includes an inner terminal 10, an inner housing 20, an outer terminal 30, a shield shell 40, an outer housing 50, and a lid member (lid 60). The board connector 1 is mounted on a circuit board 2 and used (see FIG. 1). In the present embodiment, an opening 50a side of the outer housing 50 is referred to as the front side FR, and the circuit board 2 side thereof is referred to as a rear side RR.

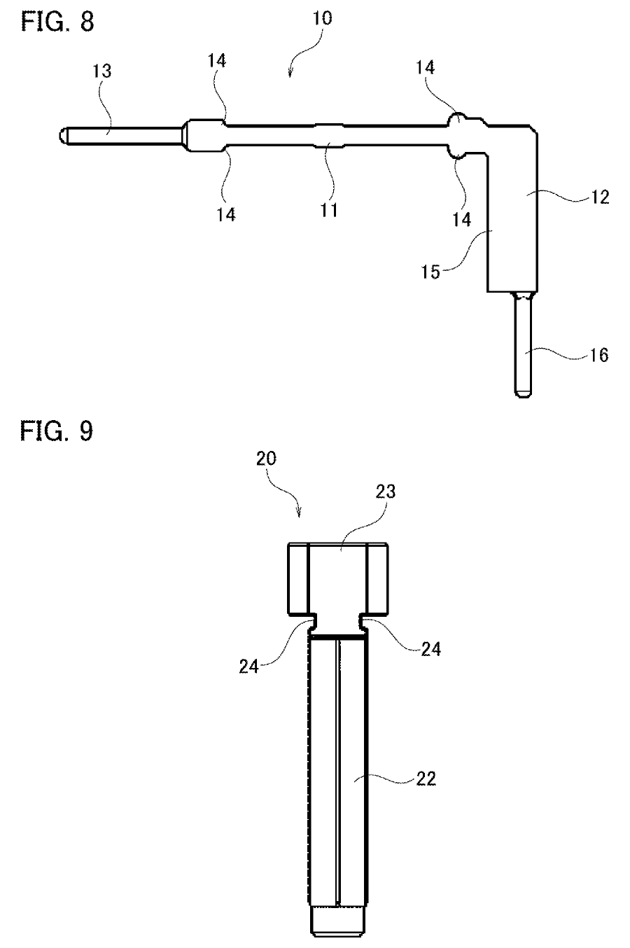

The inner terminal 10 illustrated in FIG. 8 is electrically connected to the circuit board 2, and contacts with a mating inner terminal of the mating connector (omitted in illustration). The inner terminal 10 is also referred to as an inner conductor. In the present embodiment, the inner terminals 10 are arranged in two vertical stages, with two being arranged at an upper stage and two being arranged at a lower stage.

As illustrated in FIG. 8, the inner terminal 10 at the lower stage is formed into a bar-like shape of metal or the like, includes a main body portion 11 and a hanging portion 12, and is formed into an L-like shape. The main body portion 11 is accommodated in an accommodation portion 21 of the inner housing 20. A distal end portion 13 of the main body portion 11 contacts with the mating inner terminal (omitted in illustration), and is conducted therewith. A press-fit protrusion 14 is formed at the main body portion 11. A plurality of (four in the present embodiment) press-fit protrusions 14 are formed at the main body portion 11, and are provided so that the inner terminal 10 is press-fitted into the accommodation portion 21 of the inner housing 20. The hanging portion 12 extends downward from a rear end portion of the main body portion 11. At an end surface of the hanging portion 12 on the front side FR, an abutting surface 15 that abuts against the inner housing 20 at the time of assembly of the inner terminal 10 is formed. At a lower end portion of the hanging portion 12, a connection portion 16 is formed. The connection portion 16 contacts with the circuit board 2, and is conducted therewith. The connection portion 16 is inserted into a through hole formed in the circuit board 2, and is fixed thereto via solder.

Although the inner terminal 10 at the upper stage differs in length from the inner terminal 10 at the lower stage, their structures are similar, and thus detailed description thereof is omitted.

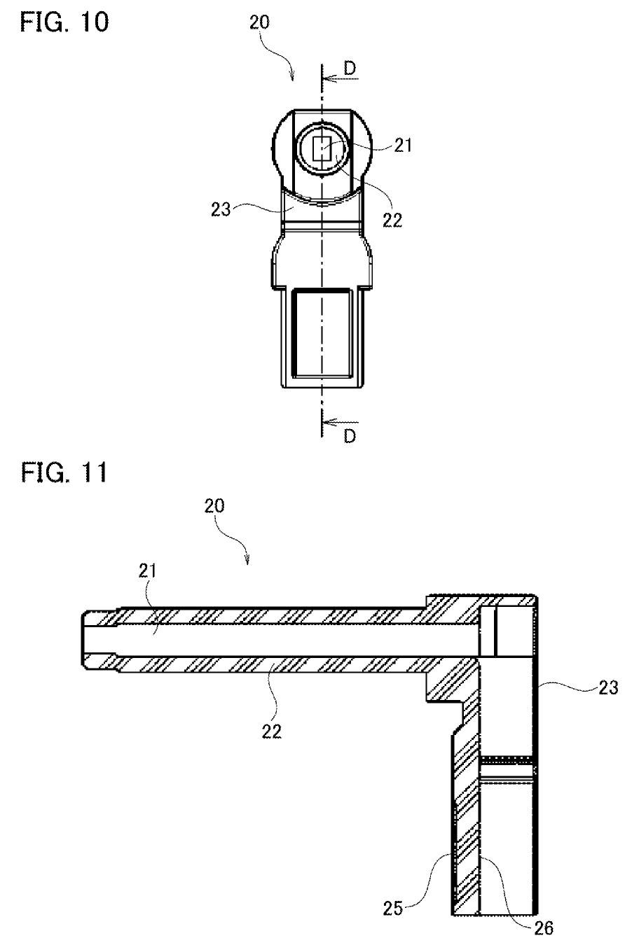

As illustrated in FIG. 9 to FIG. 13, the inner housing 20 includes the accommodation portion 21 that accommodates the inner terminal 10. The inner housings 20 are arranged in two vertical stages, with two being arranged at an upper stage and two being arranged at a lower stage.

As illustrated in FIG. 9 to FIG. 11, the inner housing 20 at the upper stage is formed of a synthetic resin or the like, includes a main body portion 22 and a hanging portion 23, and is formed into an L-like shape. The main body portion 22 is formed into a tubular shape, and includes the accommodation portion 21 that accommodates the inner terminal 10. The main body portion 22 is accommodated in a small diameter portion 33 of the outer terminal 30. Further, a cutout 24 is formed on each of the right and left sides of the main body portion 22. The hanging portion 23 performs positioning so as to connect the inner terminal 10 to the circuit board 2, and extends downward from a rear end portion of the main body portion 22. At a front surface of the hanging portion 23, an abutting surface 25 that abuts against the shield shell 40 is formed (see FIG. 11). Further, a rear portion of the hanging portion 23 is cut out so that the inner terminal 10 is accommodated, and an abutting surface 26 that abuts against the inner terminal 10 is formed at an end surface inside the hanging portion 23 being cut out (see FIG. 11).

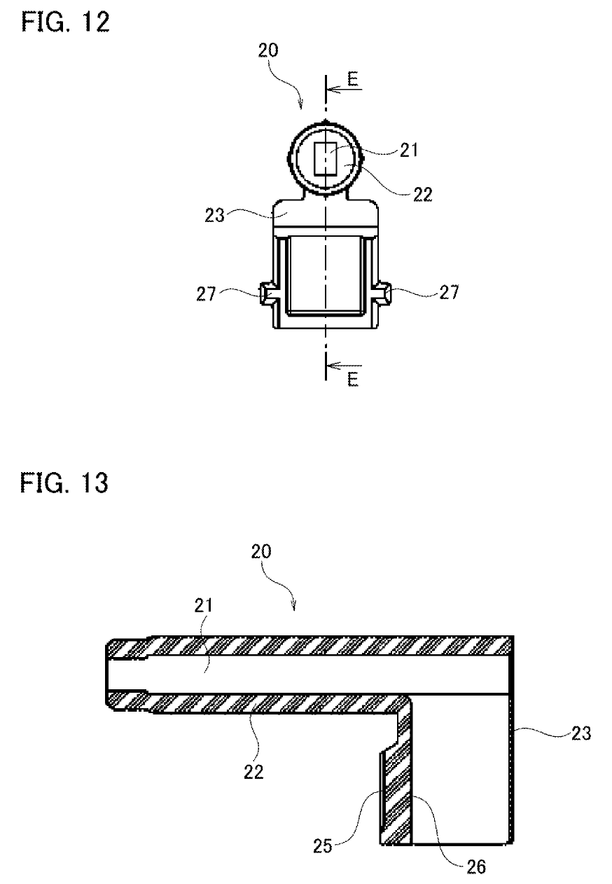

Although the inner housing 20 at the lower stage illustrated in FIG. 12 and FIG. 13 differs in length from the inner housing 20 at the upper stage, their structures are similar, and thus only differences therebetween are described.

As illustrated in FIG. 12, a rib 27 is provided on each of the right and left sides of the inner housing 20 at the lower stage.

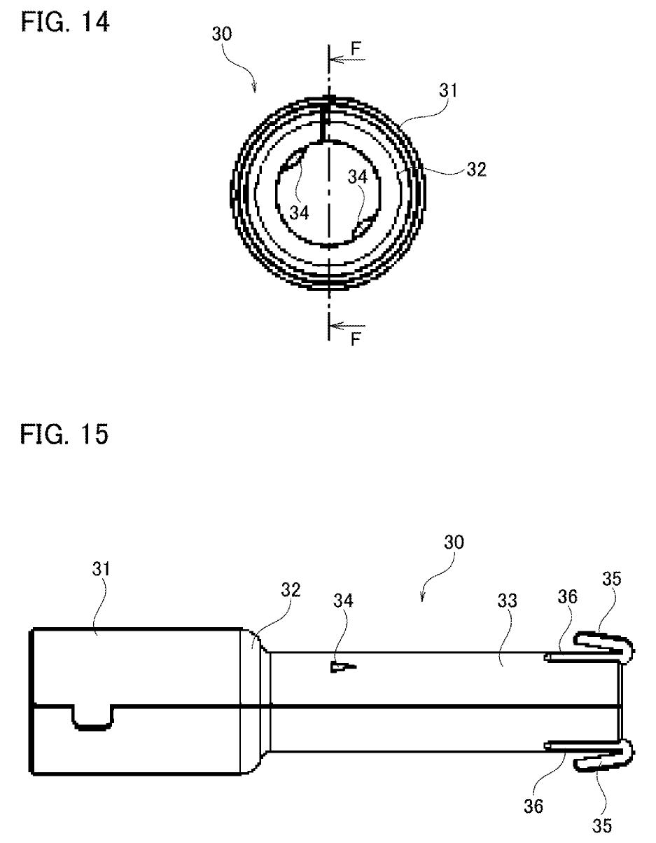

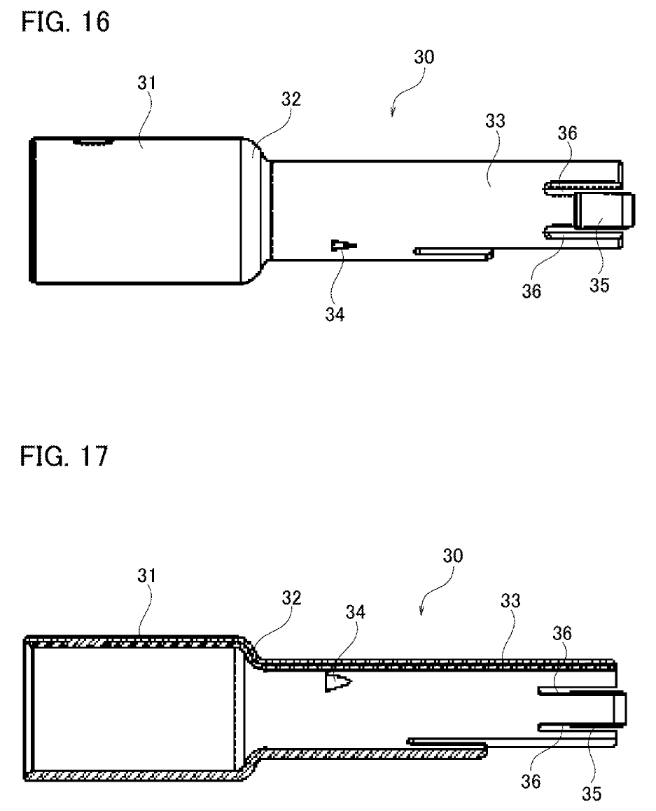

The outer terminal 30 illustrated in FIG. 14 to FIG. 17 covers a part of the inner terminal 10, is electrically connected to the circuit board 2, and contacts with a mating outer terminal of the mating connector (omitted in illustration). The outer terminal 30 is also referred to as an outer conductor. The outer terminals 30 are arranged in two vertical stages, with two being arranged at an upper stage and two being arranged at a lower stage.

As illustrated in FIG. 14 to FIG. 17, the outer terminal 30 is formed into a stepped cylindrical shape of metal or the like. The outer terminal 30 includes a large diameter portion 31, a joining portion 32, and the small diameter portion 33. The large diameter portion 31 contacts with the mating outer terminal (omitted in illustration), and is conducted therewith. The joining portion 32 is positioned between the large diameter portion 31 and the small diameter portion 33 is positioned by abutting against the outer housing 50. The small diameter portion 33 is a portion in which the inner housing 20 is accommodated. At the small diameter portion 33, a plurality of locking portions 34 are formed by cutting and raising so as to lock the inner housing 20. At a terminal end portion (the end portion on the rear side RR) of the small diameter portion 33, a spring locking piece portion 35 that is folded toward the front side FR in advance (is bent into a folded shape) is formed, and the spring locking piece portion 35 is locked after assembly to the shield shell 40. A slit 36 is formed on each of the both sides of the spring locking piece portion 35.

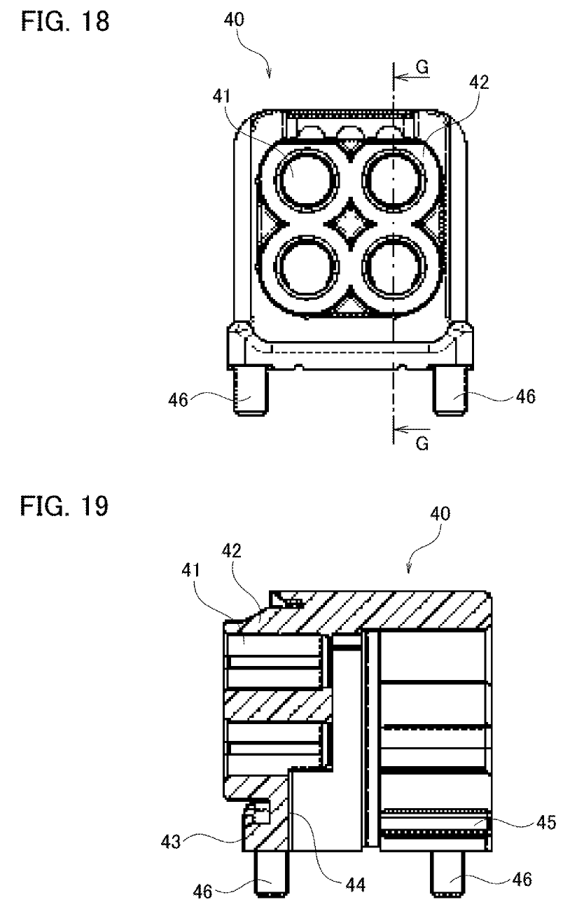

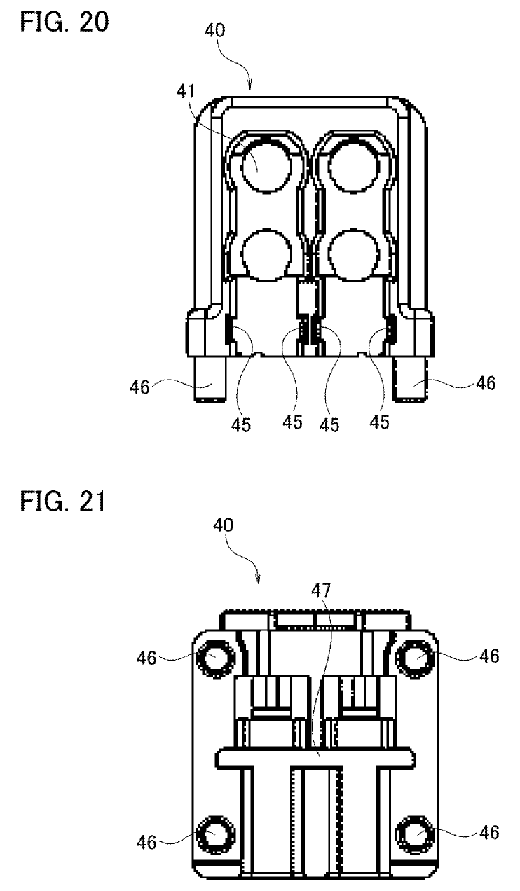

The shield shell 40 illustrated in FIG. 18 to FIG. 21 includes a holding hole portion 41 through which the outer terminal 30 passes for holding the outer terminal 30. The shield shell 40 is formed of metal or the like.

As illustrated in FIG. 18 to FIG. 21, the shield shell 40 includes a front portion 42 that is assembled to the outer housing 50 and the holding hole portion 41 in which the outer terminal 30 is accommodated. At an end surface of the front portion 42, an abutting surface 43 that abuts against the outer housing 50 is formed (see FIG. 19). At an end surface of the holding hole portion 41, an abutting surface 44 that abuts against the inner housing 20 is formed (see FIG. 19). At an terminal end portion (the end portion on the rear side RR) of the holding hole portion 41, an accommodation recess portion 41a that accommodates the spring locking piece portion 35 formed at an end terminal portion (the end portion on the rear side RR) of the small diameter portion 33 of the outer terminal 30 is formed (see FIG. 7). Further, at a groove lower portion assembled to the inner housing 20, guide-rail cutouts 45 are formed as a pair on right and left sides, and the rib 27 of the inner housing 20 at the lower stage can be inserted through the cutout 45. At the shield shell 40, a plurality of (four in the present embodiment) leg portions 46 that protrude downward from a lower surface of the shield shell 40 are formed. The leg portion 46 is electrically connected to the circuit board 2. The leg portion 46 is inserted into a through hole formed in the circuit board 2, and is fixed thereto via solder. Further, in the lower surface of the shield shell 40 at which the leg portion 46 is formed, an accommodation portion 47 for assembling and accommodating the lid 60 is formed to be opened (see FIG. 21).

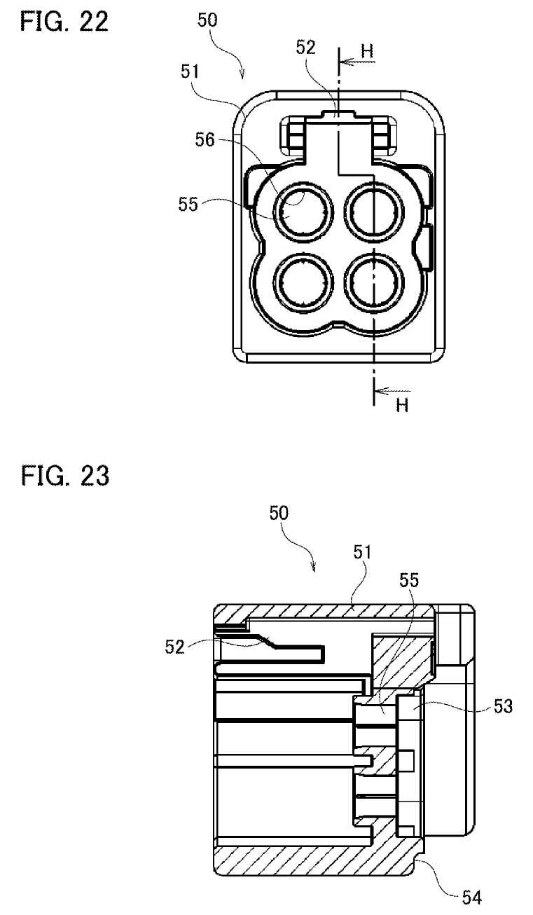

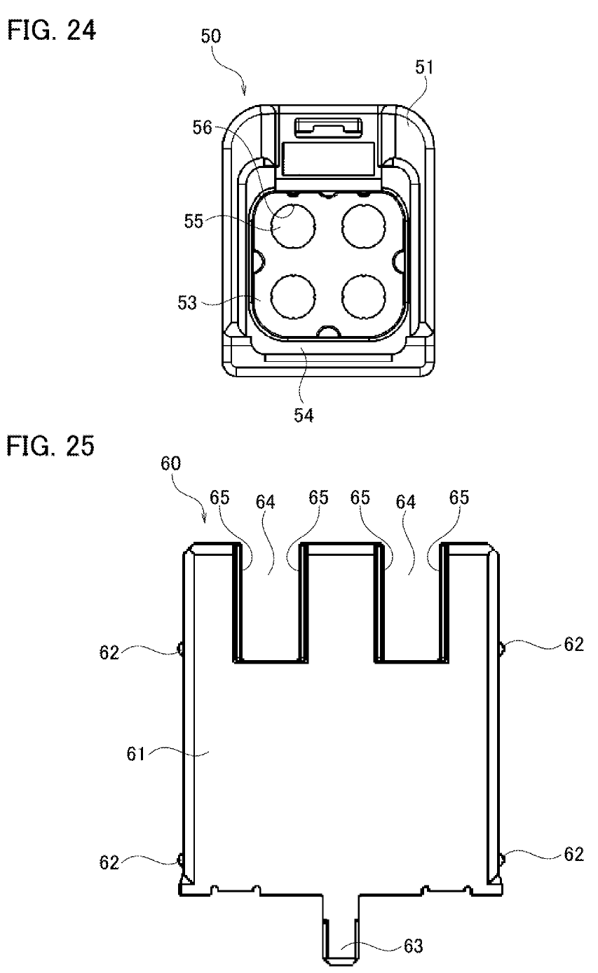

The outer housing 50 illustrated in FIG. 22 to FIG. 24 accommodates and holds the outer terminal 30 and the shield shell 40.

As illustrated in FIG. 22 to FIG. 24, the outer housing 50 includes a main body portion 51 formed of a synthetic resin or the like. At an upper part of the main body portion 51, a lock beak 52 that locks the mating connector (omitted in illustration) is formed. Inside the main body portion 51, the accommodation chamber 53 that accommodates the front portion 42 of the shield shell 40 is formed, and an abutting surface 54 that abuts against the shield shell 40 is formed at an end surface of the accommodation chamber 53 (see FIG. 23). Further, inside the main body portion 51, an accommodation hole portion 55 is formed for assembling the outer terminal 30, and a cylindrical projection portion 56 against which the outer terminal 30 abuts is formed on an inner periphery of the accommodation hole portion 55. The accommodation hole portions 55 are arranged in two vertical stages, with two being arranged at an upper stage and two being arranged at a lower stage. In the present embodiment, a plurality of (four in the present embodiment) cylindrical projection portions 56 are formed at an interval in the circumferential direction.

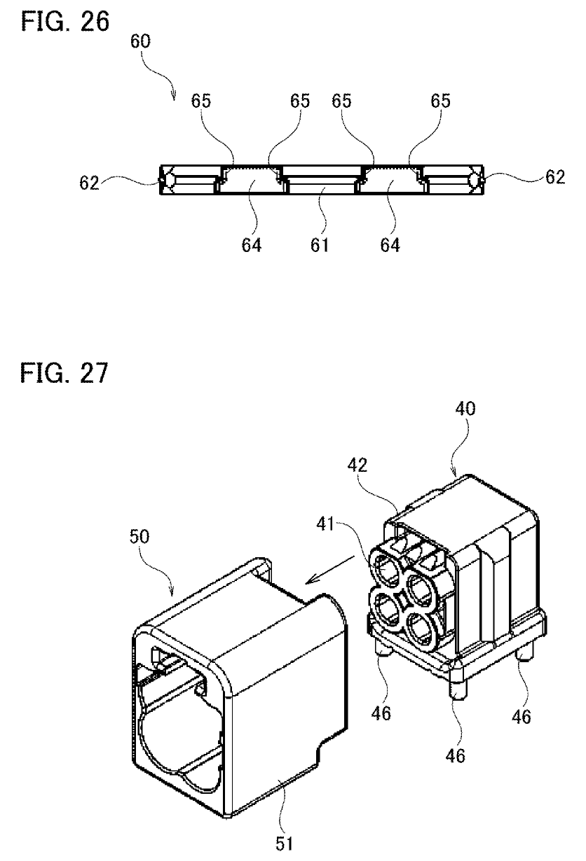

The lid 60 illustrated in FIG. 25 and FIG. 26 is assembled to the shield shell 40.

As illustrated in FIG. 25 and FIG. 26, the lid 60 is assembled to the shield shell 40, and includes a function of partitioning the inside of the shield shell 40 into the front part, the rear part, the right part, and the left part. The lid 60 includes a lid main body 61 formed into a plate-like shape of a metal or the like. A press-fit protrusion 62 is formed on each of the right and left sides of the lid main body 61. The press-fit protrusion 62 is provided so that the lid 60 is press-fitted into and assembled to the accommodation portion 47 of the shield shell 40. At the lid main body 61, a leg portion 63 that protrudes downward from a lower end surface of the lid main body 61 is formed. The leg portion 63 is inserted into a through hole corresponding to an earth portion of a conductor pattern formed on the circuit board 2, and is fixed thereto via solder. Further, the lid main body 61 of the lid 60 extends up to the outer terminal 30 at the upper stage, and an upper end of the lid main body 61 is positioned substantially at the same height as an upper end of the hanging portion 23 of the inner housing 20 at the upper stage. Further, in an upper end portion of the lid main body 61, a cutout 64 through which the main body portion 22 of the inner housing 20 at the upper stage can pass is formed. In the present embodiment, two cutouts 64 are formed corresponding to the inner housings 20 at the upper stage. Further, at an inner portion of the cutout 64, a projecting portion 65 that is engaged with the cutout 24 formed in the main body portion 22 of the inner housing 20 is formed.

An assembly procedure of the board connector 1 is described below.

As illustrated in FIG. 27, the shield shell 40 is assembled to the outer housing 50.

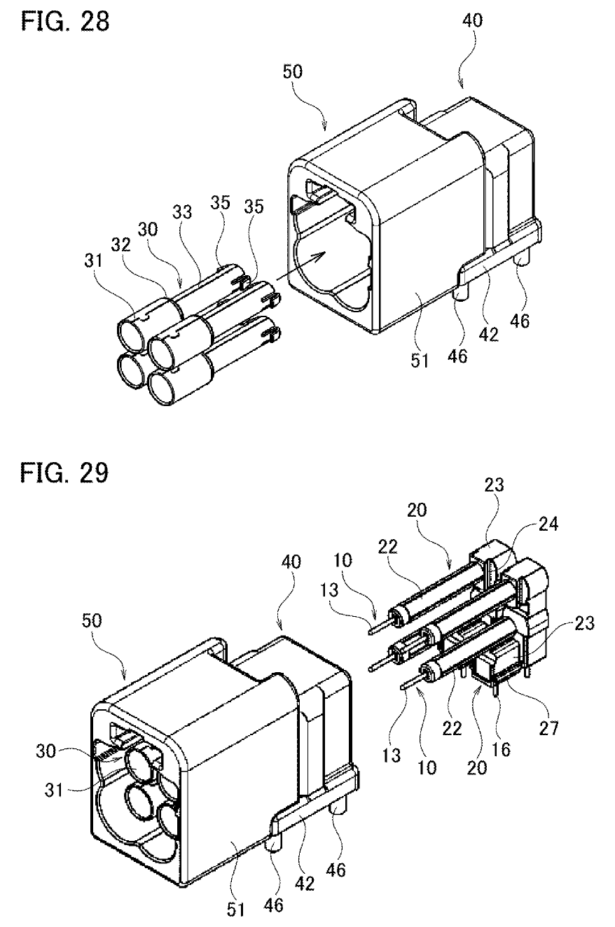

As illustrated in FIG. 28, the outer terminal 30 is assembled to the outer housing 50.

As illustrated in FIG. 29, the inner housing 20 to which the inner terminal 10 is assembled in advance is assembled to the shield shell 40.

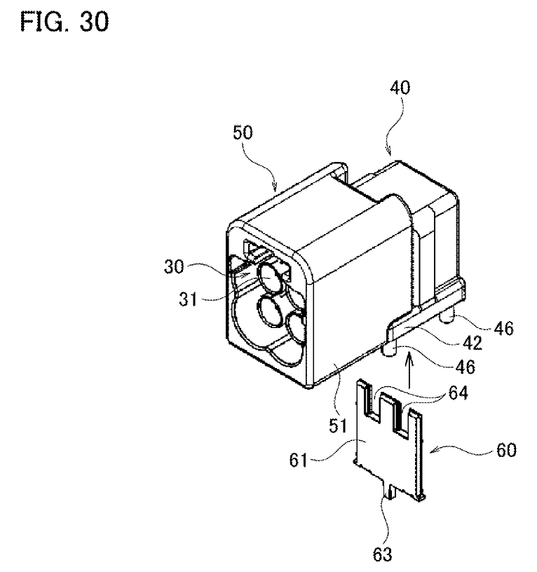

As illustrated in FIG. 30, the lid 60 is assembled to the shield shell 40.

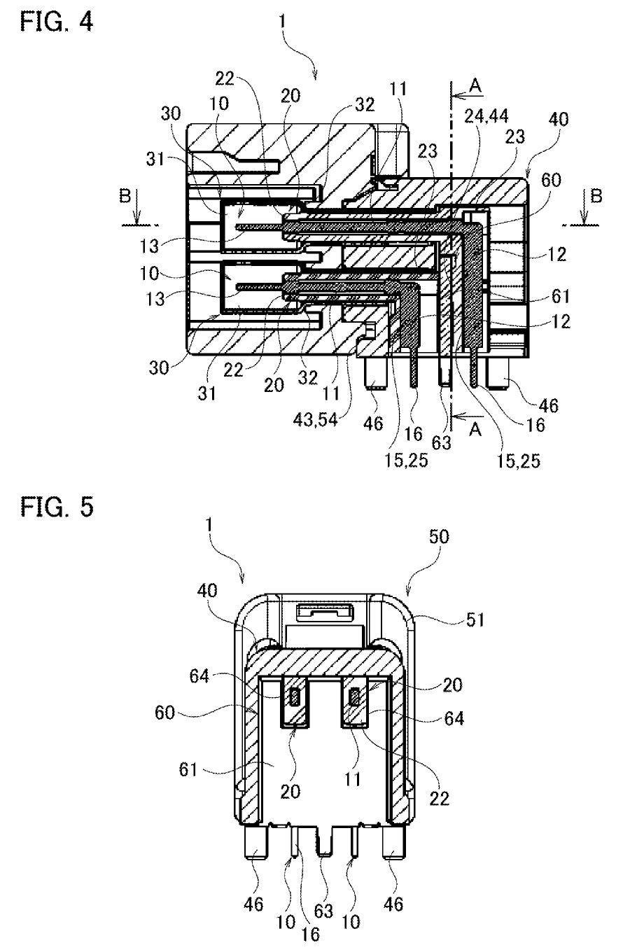

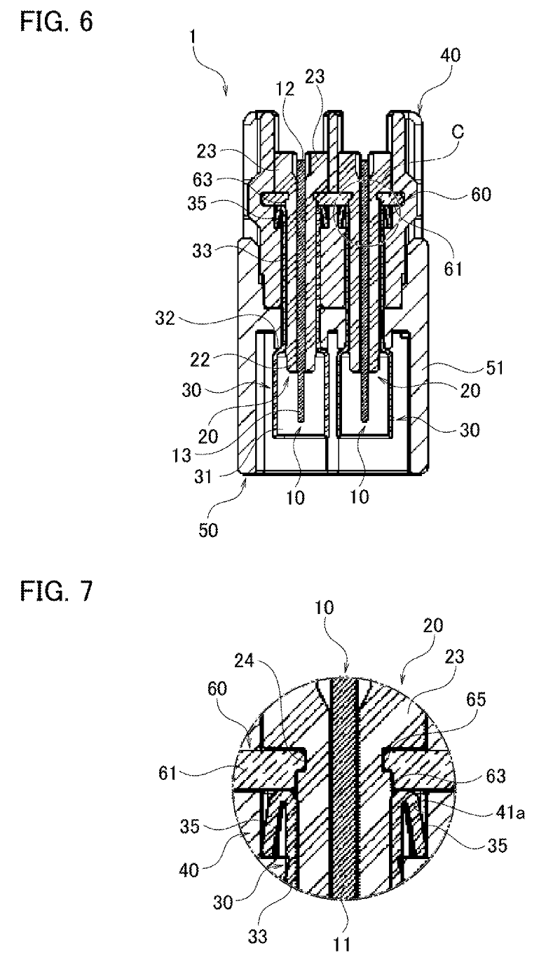

When the lid 60 is assembled to the shield shell 40, the spring locking piece portion 35 of the outer terminal 30 contacts with the lid main body 61 of the lid 60 assembled to the shield shell 40. In this state, the spring locking piece portion 35 of the outer terminal 30 at the lower stage is sandwiched between the shield shell 40 and the lid 60, and the lid 60 covers a back surface of the outer terminal 30 at the lower stage (see FIG. 4). The cutout 64 provided at the upper end portion of the lid main body 61 passes through the inner housing 20 at the upper stage, and thus there is almost no gap between a front surface of the lid main body 61 and a rear end of the inner housing 20 at the upper stage (see FIG. 6 and FIG. 7). Further, the cutout 64 provided in the upper end portion of the lid main body 61 passes through the inner housing 20, and thus the lid 60 covers the back surface of the outer terminal 30 at the upper stage (see FIG. 6 and FIG. 7).

As described above, the board connector 1 according to an aspect of the present embodiment includes the inner terminal 10 that is electrically connected to the circuit board 2, and contacts with the mating inner terminal of the mating connector, and the accommodation portion 21 that includes the inner housing 20 accommodating the inner terminal 10. The board connector 1 includes the outer terminal 30 that covers a part of the inner terminal 10, is electrically connected to the circuit board 2, and contacts with the mating outer terminal of the mating connector, and the shield shell 40 that includes the holding hole portion 41 through which the outer terminal 30 passes for holding the outer terminal 30. The board connector 1 includes the outer housing 50 that accommodates and holds the outer terminal 30 and the shield shell 40, and the lid member (the lid 60) that is assembled to the shield shell 40. The outer terminal 30 includes the large diameter portion 31 that contacts with the mating outer terminal, and is conducted therewith, the joining portion 32 that is positioned by abutting against the outer housing 50, and the small diameter portion 33 in which the inner housing 20 is accommodated. The spring locking piece portion 35 that is bent into a folded shape is formed at the terminal end portion (the end portion on the rear side RR) of the small diameter portion 33, and the spring locking piece portion 35 is sandwiched between the shield shell 40 and the lid member (the lid 60).

By the spring locking piece portion 35 of the outer terminal 30 contacting with the shield shell 40 by a spring load, the outer terminal 30 and the shield shell 40 can be securely brought into contact with each other, and manufacturing variations can be absorbed. Further, by the lid 60 extending up to the outer terminal 30 at the upper stage, shielding performance of the shield shell 40 and crosstalk reduction characteristics between the terminals at the upper stage are also improved, and a holding force of the inner housing 20 can also be secured.

According to the present embodiment described above, it is possible to provide the board connector 1 capable of improving a holding force of the outer terminal 30 with respect to the shield shell 40.

In the board connector 1, the plurality of spring locking piece portions 35 may be formed at an interval in the circumferential direction of the small diameter portion 33.

Thus, by the spring locking piece portion 35 of the outer terminal 30 contacting with the shield shell 40 by a spring load, the outer terminal 30 and the shield shell 40 can be securely brought into contact with each other, and manufacturing variations can be absorbed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A board connector comprising:
an inner terminal that is electrically connected to a circuit board, and contacts with a mating inner terminal of a mating connector;
an inner housing that includes an accommodation portion accommodating the inner terminal;
an outer terminal that covers a part of the inner terminal, is electrically connected to the circuit board, and contacts with a mating outer terminal of the mating connector;
a shield shell that includes a holding hole portion through which the outer terminal passes for holding the outer terminal;
an outer housing that accommodates and holds the outer terminal and the shield shell; and
a lid member that is assembled to the shield shell, wherein
the outer terminal includes:
a large diameter portion that contacts with the mating outer terminal, and is conducted therewith;
a joining portion that is positioned by abutting against the outer housing; and
a small diameter portion in which the inner housing is accommodated, and
a spring locking piece portion that is bent into a folded shape is formed at a terminal end portion of the small diameter portion, the spring locking piece portion being sandwiched between the shield shell and the lid member.

2. The board connector according to claim 1, wherein
a plurality of the spring locking piece portions are formed at an interval in a circumferential direction of the small diameter portion.
